(19) United States
(12) Patent Application Publication
(10) Pub. No.: US 2007/0169326 A1
(43) Pub. Date: Jul. 26, 2007

(54) Bottle cap with integrated valve core remover

(76) Inventor: Bryan Douglas Smith, Arroyo Grande, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/315,411

(22) Filed: Dec. 22, 2005

(51) Int. Cl. B23P 19/04

(52) U.S. Cl. 29/221.5

(57) ABSTRACT

A bottle cap with an integrated valve core remover is provided so that the process of sealing an object, such as a tire, with sealant in a container is simplified.

### FIELD OF INVENTION

This invention pertains generally to a container cap and particularly to a cap for a sealant container.

### BACKGROUND

Various tire or tube sealant formulas are available on the market. These sealants usually include a rubber composition and are sold as a non-pressurized liquid in a pressure-tight container. The sealant is usually “injected,” through the valve stem, into a tire that needs to be sealed. Thus, to use the sealant, the valve core of the tire must be removed so that the sealant can enter the tire. Once the valve core is removed, a hose or a tubing is connected to the sealant container and the opened valve allowing the sealant to flow from the contained into the object being sealed and inflated such as a tire.

Sometimes, the container holds not only the sealant but also a liquefied gas (e.g., a propane/butane mixture) that helps push the sealant out of the container during usage. The liquefied gas, which is de-pressurized as it is expelled from the container, helps inflate the tire. For the sealants that are not packaged with the liquefied gas, the sealant is installed by hand and then a compressed air source such as an air compressor is used after installation of the sealant to inflate the tire.

With any type of sealant that does not include liquefied gas, it is necessary to remove the tire valve core in order to insert the sealant into the object to be sealed. In particular, a container of sealant cannot be used to seal a tire or other object without also using a valve core remover to remove the valve core and a piece of tubing to connect the sealant container to the object to be sealed. Typically, the sealant container is provided with a valve core remover, but the valve core remover is a relatively small part that is easily lost or misplaced. If the valve core remover is lost, the sealant cannot be used to seal the object until another valve core remover is located.

It is desirable to provide a cap for a sealant container that makes it easier to locate the valve core remover and would relieve the user of the hassle of having to remember to pack the valve core remover, thereby making tire sealing an easier process and it is to this end that the invention is directed.

### SUMMARY OF THE INVENTION

In one aspect, the invention is a device that is a cap for a container where the container may contain a sealant material. The device may include an integrated valve core removal tool that makes the process to seal an object, such as a tire, much easier using a sealant in a container.

In another aspect, the invention is a sealant kit that includes a container holding a sealant, a bottle top attached to the sealant container, and a cap for closing the bottle top when the container is not in use. The bottle top has an opening through which the sealant leaves the container. The cap is integrated with a valve core removal tool.

In yet another aspect, the invention is a method of sealing a tire. The sealing is done by obtaining a container of sealant, detaching the cap from the container, and using a valve core removal tool integrated with the cap to remove a valve core from an object to be sealed.

### BRIEF DESCRIPTION OF THE DRAWINGS

FIG. 1 is a side view of a conventional bottle top that is commonly used for sealant containers;

FIG. 2 is a frontal view of a dual-function cap in accordance with the invention;

FIG. 3 is a side view of the cap of FIG. 2;

FIG. 4 is the cap of FIG. 2 in combination with the conventional bottle top of FIG. 1;

FIG. 5 is a bottom view of the cap; and

FIG. 6 is a top view of the cap of FIG. 2.

### DETAILED DESCRIPTION OF THE INVENTION

Embodiments of the invention are described herein in the context of a tire sealant in a container wherein the cap has the integrated valve core remover. However, it is to be understood that the embodiments provided herein are just preferred embodiments, and the scope of the invention is not limited to the applications or the embodiments disclosed herein. For example, the cap may be used with other containers and used alone as a way to keep track of a valve core remover tool.

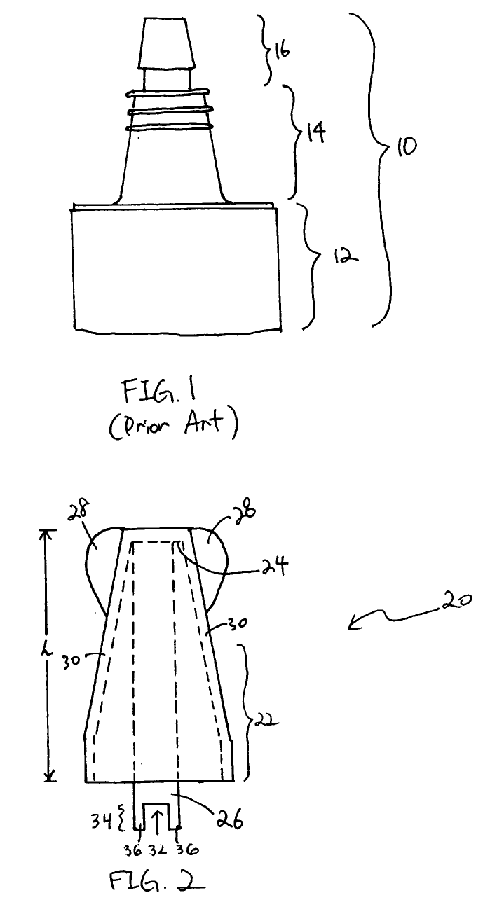

FIG. 1 is a side view of a conventional bottle top 10 that is commonly used for sealant containers. The bottle top 10 has a bottle connector portion 12, a cap connector portion 14, a spout 16, and a channel that extends through the bottle connector, cap connector and spout portions to provide a path for the sealant from a container containing the sealant through the bottle connector, cap connector and spout portions into the object to be sealed. The bottle connector portion 12 is designed to securely attach to a container of sealant, the cap connector portion 14 is designed to securely attach to a cap, and the spout 16 is designed to attach to a hose through which the sealant is “injected” into the object being sealed (e.g., a tire). The bottle top 10 shown in FIG. 1 may include a cap that covers the portions shown in FIG. 1. However, it is desirable to provide a cap that has an integrated valve core remover tool so that the valve core removal tool is not lost.

FIG. 2 is a frontal view of a cap 20 in accordance with the invention that both seals the sealant container and includes an integrated valve core removal tool. The cap 20 has a connector portion 22 that is designed to be coupled to the cap connector portion 14 of the bottle top 10 shown in FIG. 1. Thus, the cap 20 may be fitted onto an existing top 10. As an example, if the cap connector portion 14 has a set of threads, then the inner walls of the connector portion 22 may have a set of threads that interact with the threads of the cap connector portion 14 to allow the user to screw the cap 20 onto a container with the bottle top 10 shown in FIG. 1. The cap 20 may also include other coupling mechanisms that permit the cap 20 to be coupled to a container or a bottle top 10 and a cap with those other coupling mechanisms are within the scope of the invention. Furthermore, the top 10 and the cap 20 may be integrated into a single piece. The height h of the dual-function cap 20 is selected so that when the cap 20 is secured on the bottle top 10, the spout 16 is substantially closed by a ceiling portion 24 of an outer wall portion 30 of the cap 20 so that no sealant comes out of the container.

A valve core remover 26 is integrated with the cap 20 and extends from the ceiling 24 to a length greater than the height h as shown in FIG. 2. The valve core remover 26 may be made of the same material as the cap 20, such as a hard plastic material. The length of the valve core remover may be adjusted depending on the type of valve core and the type of tire for which the sealant may be used and so the invention is not limited to any particular length of valve core remover. The cap 20 may optionally include one or more protrusions 28 that may be formed on the outer surface of the cap 20 to facilitate the screwing and un-screwing of the cap 20 on the bottle top 10 or an unscrewing of a valve core using the valve core remover 26.

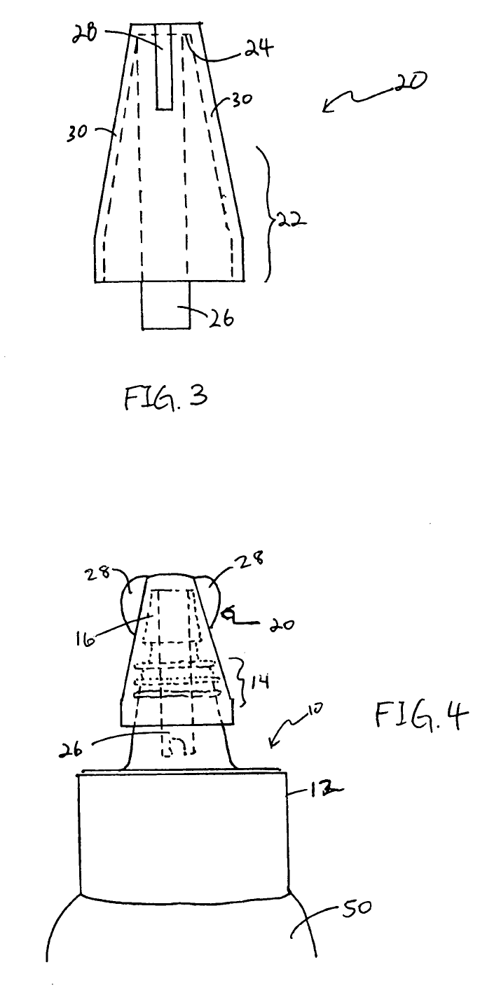

FIG. 3 is a side view of the cap 20. While the outer shell 30 around the valve core remover 26 (excluding the protrusions 28) is substantially symmetric around an axis extending through a center of the cap 20 in the direction of the valve core remover 26, the valve core remover 26 is not. The valve core remover 26 may preferably have a U-shape when seen from the front (see FIG. 2), but not when seen from the side (see FIG. 3) so that the valve core remover 26 is not symmetric about the axis. The valve core removal tool 26 may have legs of the U-shape that couple with the valve core and permits a user to unscrew the valve core using the valve core removal tool in accordance with the invention.

FIG. 4 depicts the cap 20 of the invention attached to the conventional bottle top 10. As shown, the valve core remover 26 fits through the opening of the spout 16 and extends into the cap connector portion 14. The valve core remover 26 preferably does not extend into the bottle connector portion 12 so that before the sealant is first used, a flat sheet of plastic or paper material may be laid at the interface between the bottle connector portion 12 and the cap connector portion 14 to prevent any sealant leakage. The bottle top 10 may be attached to a container 50 as shown, wherein the container 50 holds a fluid (e.g., a sealant).

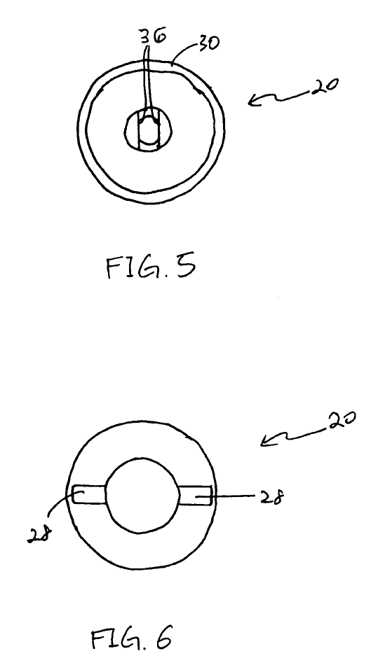

FIG. 5 is a bottom view of the cap 20. As shown in FIGS. 2 and 5, the outer shell 30 has a substantially round cross section. The unattached end of the valve core remover 26 has an indented section 32 and a clasping section 34 that form a U-shape. The clasping section 34 has a pair of flat leg surfaces 36 facing each other so that they can hold onto a valve core which is inserted into the indented section 32. In operation, the user may fit the leg surfaces 36 into the valve core so that the user may unscrew the valve core using the valve core removal tool.

FIG. 6 is a top view of the cap 20 wherein the protrusions 28 are shown. In a preferred embodiment, the protrusions 28 may be tabs that permit the user to more easily turn the valve core removal tool. The cap 20 with the integrated valve removal tool has the benefit that the valve removal tool is integrated into the cap (and therefore cannot be lose of misplaced) so that the process for sealing a tire (including removal of the valve core) is easily for the user.

While the foregoing has been with reference to a particular embodiment of the invention, it will be appreciated by those skilled in the art that changes in this embodiment may be made without departing from the principles and spirit of the invention, the scope of which is defined by the appended claims.

What is claimed is:

1. A device for closing a container, wherein the device comprises a valve core removal tool that is integrated into the device.

2. The device of claim 1 further comprising:
an outer shell that is designed to fit around a top of the container to close the container opening; and
a valve core removal tool attached to an inner wall of the outer shell.

3. The device of claim 2, wherein the valve core removal tool extends from the inner wall in such a way that the valve core removal tool extends into a fluid path in the bottle top when the cap is combined with a bottle.

4. The device of claim 2 further comprising one or more protrusions on an outer surface of the outer shell.

5. The device of claim 2, wherein the outer shell has a substantially round cross section.

6. The device of claim 2, wherein the inner wall of the outer shell is threaded.

7. The device of claim 1 wherein the valve core removal tool further comprises a clasping section that is capable of interacting with a valve core so that the valve core can be removed using the valve core removal tool.

8. The device of claim 7, wherein the clasping section further comprises an indent portion and a pair of leg portions that form a U shape wherein the pair of leg portions interact with the valve core.

9. A sealant container kit comprising:
a container holding a sealant;
a bottle top, attached to the container, that has an opening through which the sealant leaves the container; and
a cap for closing the bottle top when sealant is not being released from the container, wherein the cap further comprises a valve core removal tool that is integrated into the cap.

10. The kit of claim 9, wherein the cap has an outer shell around the valve core removal tool, wherein the outer shell is designed to fit around the bottle top.

11. The kit of claim 10, wherein the valve core removal tool extends from an inner wall of the outer shell along a longest direction of the cap.

12. The kit of claim 10 further comprising protrusions on an outer surface of the cap.

13. A method of sealing a tire comprising:
obtaining a container holding a sealant, the container attached to a bottle top for dispensing the sealant and a cap around the bottle top to prevent sealant leakage;
detaching the cap from the container; and
using a valve core removal tool that is integrated with the cap to remove a valve core from an object to be sealed.

14. The method of claim 13, wherein the valve core removal tool is attached to an inner wall of the cap.
